(19) United States
(12) Patent Application Publication
(10) Pub. No.: US 2007/0140217 A1
(43) Pub. Date: Jun. 21, 2007

(54) System and method to support VoIP session by sharing existing packet data resource

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/305,067

(22) Filed: Dec. 16, 2005

(51) Int. Cl. H04Q 7/24; H04L 12/66; H04J 3/22; H04J 3/16

(52) U.S. Cl. 370/352; 370/468; 370/338

(57) ABSTRACT

An apparatus in one example has: a terminal operatively couple by at least one of a fundamental channel and a supplemental channel to a telecommunication system having packet data capability; the terminal having a packet data session that is established on a packet data path on the fundamental channel; a VoIP session request that is sent from the terminal to the telecommunication system; the VoIP request having a priority that is higher than a priority of the packet data session request if the supplemental channel is not available wherein use of the fundamental channel between the VoIP session and the packet data session is shared; and if the supplemental channel is available, the VoIP session established on the fundamental channel and the packet data session established on the supplemental channel.

### TECHNICAL FIELD

The invention relates generally to telecommunication networks, and more particularly to a telecommunications network that supports VoIP session setup through re-using an existing packet data resource, if a packet data session is already setup.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA).

The IP Multi-Media Subsystem (IMS) is an IP multimedia and telephony core network. It is defined by 3GPP and 3GPP2 standards and organizations based on IETF Internet protocols. IMS is access independent as it supports IP to IP session over wireline IP, 802.11, 802.15, CDMA, packet data along with GSM/EDGE/UMTS and other packet data applications. IMS is standardized reference architecture. IMS consists of session control, connection control and an applications services framework along with subscriber and services data. It enables new converged voice and data services, while allowing for the interoperability of these converged services between subscribers.

A packet data session refers to the continuous use of packet data service by the user. A packet data session begins when the user invokes packet data service. A packet data session ends when the user or the network terminates packet data service.

The CDMA2000 standard supports different modes of data communications. For relatively low rates of data messaging, a fundamental channel (FCH) can handle both signaling and data messaging. Signaling refers to the communications between a mobile and a base station that are used by the mobile and the base station to control the communications links between them, while messaging refers to the information passed through the base station to and from the end nodes of those communications, where the mobile is one of those end nodes. For high-rate data messaging, a supplemental channel (SCH) can be used for data messaging, while the fundamental channel handles the signaling between the mobile and the base station.

With more service providers offering VoIP (Voice over Internet Protocol) service in their network, many subscribers are now able to have both packet data service and VoIP service at the same time. From the service provider's point of view, it is more efficient to manage packet resources as a whole instead of managing packet data and VoIP resources separately. However, as spectrum is limited and high speed packet data usually takes more resources than VoIP calls, it is desirable for service providers to save as much packet resources as possible or even re-use some packet resources if applicable to serve more customers and bring in more revenue. Current practice in the art cannot support both high-speed packet data sessions and VoIP services simultaneously via one packet data session. It is a drawback of the current art that high-speed packet data services and VoIP services require two sessions.

Thus there is a need in the art for a system that supports VoIP session setup through re-using an existing packet data resource, if a packet data session is already setup.

### SUMMARY

One implementation encompasses an apparatus. This apparatus may comprise: a terminal operatively couple by at least one of a fundamental channel and a supplemental channel to a telecommunication system having packet data capability; the terminal having a packet data session that is established on a packet data path on the fundamental channel; a VoIP session request that is sent from the terminal to the telecommunication system; the VoIP request having a priority that is higher than a priority of the packet data session request if the supplemental channel is not available wherein use of the fundamental channel between the VoIP session and the packet data session is shared; and if the supplemental channel is available, the VoIP session established on the fundamental channel and the packet data session established on the supplemental channel.

One implementation encompasses a method. This embodiment of the method may comprise: conducting a packet data session with packet data resources; and establishing a VoIP session by sharing the existing packet data resources with the packet data session.

### DESCRIPTION OF THE DRAWINGS

Features of exemplary implementations will become apparent from the description, the claims, and the accompanying drawings in which:

FIG. 1 is an embodiment in a telecommunication network according to the present method and apparatus;

FIG. 2 is an embodiment of the present method for supporting VoIP session setup through re-using an existing packet data resource, if a packet data session is already setup; and

FIG. 3 is another embodiment of the present method for supporting VoIP session setup through re-using an existing packet data resource, if a packet data session is already setup.

### DETAILED DESCRIPTION

Present methodologies for embodiments of the system comprise establishing a VoIP session on top of an existing packet data session, re-using existing packet resources for the VoIP session setup if a packet data session is already up, and giving the VoIP session higher priority than a packet data session if both of them are active at the same time.

VoIP (voice over IP—that is, voice delivered using the Internet Protocol) is a term used in IP telephony for a set of facilities for managing the delivery of voice information using the Internet Protocol. In general, this means sending voice information in digital form in discrete packets rather than in the traditional circuit-committed protocols of the public switched telephone network. In addition to IP, VoIP uses the real-time protocol to help ensure that packets get delivered in a timely manner over a packet-switched data network, such as the Internet.

A packet-switched data network is a data communications network that is based on the principles of packet switching, as opposed to circuit switching that is used in public telephone networks. Packet-switched networks do not establish physical communication channels between communicating devices like circuit-switched networks do. Instead, signals are formed into fixed-length packets that are affixed with a source and destination address and packet ordering details. The packets then rely on network routers to read the address data and route the packets through the network to their destinations. When the packets arrive at the receiving device, the packet ordering data is used to reassemble the original signal. One advantage of packet-switched networks is that packets from different sources going to different destinations can share common data pathways.

Embodiments of the present method and apparatus operate in very general terms as follows. A mobile subscriber may subscribe to both packet data and VoIP services. The subscriber may open a packet data session, i.e. downloading data from a web-site. While waiting for the data to be downloaded, the subscriber may also request a VoIP session. Upon detection of the VoIP request from the same user, the system may re-prioritize the requests, give the VoIP request higher priority when using the fundamental channel, and then re-use the established packet data path to transmit the VoIP traffic data without setting up another packet session for the VoIP request. The supplemental channel may still be used for the packet data session. When the VoIP session ends, the system may give the priority back to the packet data session and may continue with data downloading if not yet finished.

In one embodiment the mobile terminal is capable of using packet data service and VoIP services. After the mobile terminal registers with the core network, it may go into a dormant session if no calls or data transfers are taking place. Thus, there is a logical IP connection that exists between the mobile terminal and the core network.

When a request for a data session or a VoIP session is sent from the mobile terminal, the existing logical IP connection may be utilized to establish a traffic channel. If, for example, the mobile terminal is already conducting a data transfer when a request for a VoIP session is sent from the mobile terminal, then use of the existing fundamental and supplemental channels may be utilized. The supplemental channel usually provides a higher data rate, in the range of 19.2 to 153 Kb/s, as compared to the 9.6 Kb/s for the fundamental channel.

Therefore, the data transfer may take place on the supplemental channel and the voice call and signaling may take place on the fundamental channel. When necessary, the voice call is given priority, since packet loss is more serious in voice as compared to data. Also, there is no delay involved in a voice call, as compared to the ability to buffer data transfers. Thus, voice traffic on the fundamental channel is given higher priority than the signaling traffic that occurs on the fundamental channel for the data transfer taking place on the supplemental channel. Therefore, this embodiment now supports VoIP session setup through re-using an existing packet data resource, when a packet data session is already setup.

Also, if the supplemental channel is fully utilized and therefore not available, the VoIP traffic and the data traffic may both occur on the fundamental channel. Here again the voice traffic is given a higher priority, but because the voice traffic is considered to occur only about 50% of the time, the fundamental channel may still be used for data traffic.

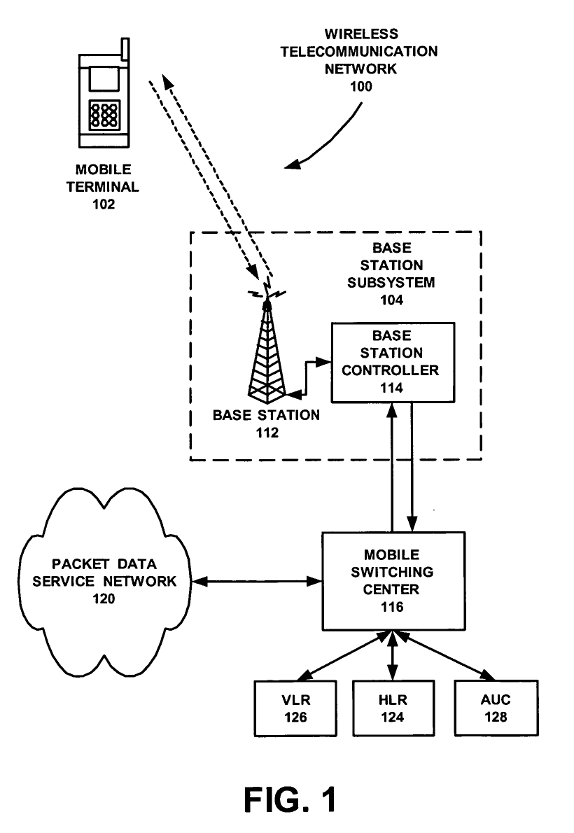

FIG. 1 depicts a wireless telecommunication network 100 that is a CDMA wireless telecommunication network. The entities that form the wireless telecommunication network 100 are defined according to their function and interface requirements. Such a wireless telecommunication network can be divided into several main elements, such as, mobile terminal 102, base station subsystem 104, and mobile switching center 116. The mobile terminal 102 may be any one of a number of devices, such as a cell phone, a personal data assistant (PDA), a laptop computer, etc.

The base station subsystem 104 connects the mobile terminal 102 and the mobile switching center 116. The base station subsystem 104 may consist of a base station 112 and a base station controller 114. The base station 112 houses the radio transceivers and antennas used in each cell of the network, and handles the radio link protocols with the mobile terminal 102. It is usually placed in the center of a cell, and its transmitting power defines the size of the cell. Each base station 112 may have, for example, between one and sixteen transceivers, depending on the number of users in the cell. The base station controller 114 may control a group of base stations and manages their radio resources. It is principally in charge of radio channel setup, handoff, frequency hopping, exchange functions and control of the radio frequency power levels of the base stations 112.

The mobile switching center 116 may have a home location register 124, a visitor location register 126, and an authentication center 128. The mobile switching center 116 may interface with a packet data service network 120, for example, the Internet.

The home location register 124 may be a database that stores information about subscribers belonging to the area controlled by the MSC 116. The home location register 124 may also store information about the services to which the mobile terminal 102 may have access.

The visitor location register 126 is utilized when a subscriber enters the coverage area of a new MSC 116. The visitor location register 126 associated with the MSC 116 requests sufficient information about the subscriber from its corresponding home location register that is associated with a home MSC, so that services to the subscriber may be maintained without further reference to the HLR of the home MSC.

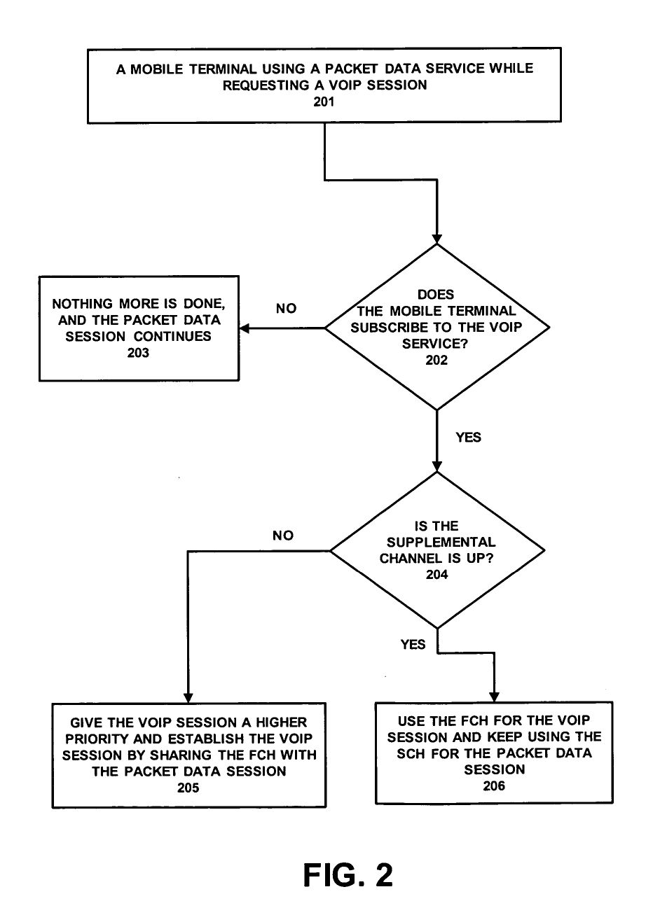

FIG. 2 is flowchart depicting an embodiment according to the present method. This embodiment of the present method may have the steps of: determining that a mobile terminal is using a packet data service while requesting a VoIP (201); checking if the mobile terminal subscribes to the VoIP service (202); if the mobile terminal is not a subscriber, then no further action is taken (203); checking, if the mobile terminal is a subscriber, if the supplemental channel is up (204); giving, if the supplemental channel is not up, the VoIP session a higher priority and establishing the VoIP session by sharing the fundamental channel with the packet data session (205); using, if the supplemental channel is up, the fundamental channel for the VoIP session and continuing to use the supplemental channel for the packet data session (206).

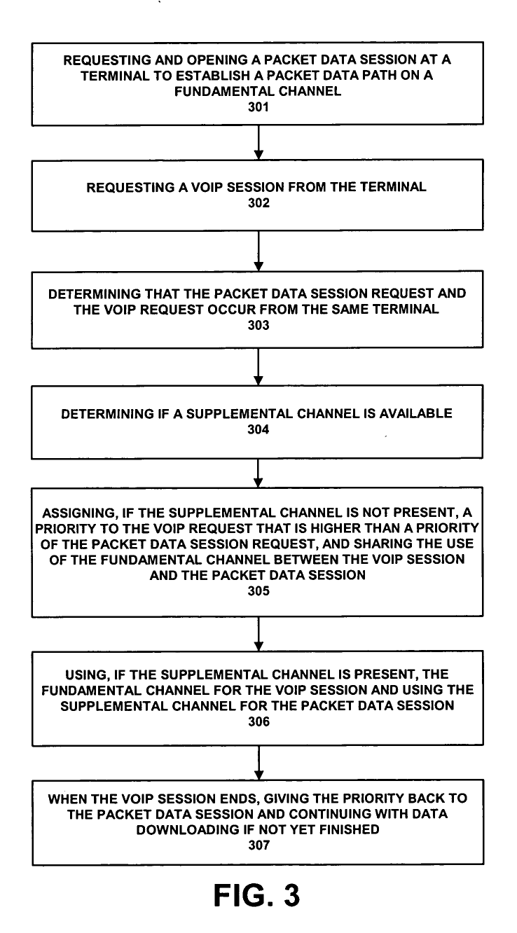

FIG. 3 is flowchart depicting another embodiment according to the present method. This embodiment of the present method may have the steps of: requesting and opening a packet data session at a terminal to establish a packet data path on a fundamental channel (301); requesting a VoIP session from the terminal (302); determining that the packet data session request and the VoIP request occur from the same terminal (303); determining if a supplemental channel is present in handling to packet data session (304); assigning, if the supplemental channel is not available, a priority to the VoIP request that is higher than a priority of the packet data session request, and sharing the use of the fundamental channel between the VoIP session and the packet data session (305); and using, if the supplemental channel is present, the fundamental channel for the VOIP session and using the supplemental channel for the packet data session (306). The method may further have the step of, when the VoIP session ends, giving the priority back to the packet data session and continuing with data downloading if not yet finished (307).

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For example, the present embodiments may be used with cdma2000 air interfaces, however embodiments according to the present method and apparatus may be utilized in other air interfaces. Also, for instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising:
conducting a packet data session with packet data resources;
establishing a VoIP session by sharing the existing packet data resources with the packet data session.

2. The method according to claim 1, wherein the method further comprises requesting and opening the packet data session at a terminal to establish a packet data path on a fundamental channel.

3. The method according to claim 2, wherein the method further comprises requesting a VoIP session from the terminal.

4. The method according to claim 3, wherein the method further comprises determining that the packet data session request and the VoIP request originate at the same terminal.

5. The method according to claim 4, wherein the method further comprises assigning a priority to the VoIP request that is higher than a priority of the packet data session request when using the fundamental channel, re-using the established packet data path to transmit VoIP traffic data without setting up another packet session for the VoIP request; and using a supplemental channel for the packet data session.

6. The method according to claim 5, wherein the method further comprises, when the VoIP session ends, giving the priority back to the packet data session and continuing with data transfer if not yet finished.

7. The method according to claim 1, wherein the method further comprises registering a mobile terminal with a core network, placing the mobile terminal in a dormant session if no voice calls or data transfers are taking place, and maintaining a logical connection the mobile terminal and the core network.

8. The method according to claim 1, wherein the packet data resources comprise a fundamental channel and a supplemental channel, data transfers taking place on the supplemental channel and voice call traffic and data signaling traffic taking place on the fundamental channel.

9. A method, comprising:
requesting and opening a packet data session at a terminal to establish a packet data path on a fundamental channel;
requesting a VoIP session from the terminal;
determining that the packet data session request and the VoIP request originate at the same terminal;
assigning a priority to the VoIP request that is higher than a priority of the packet data session request when using a fundamental channel;
re-using the established packet data path to transmit VoIP traffic data without setting up another packet session for the VoIP request; and
using a supplemental channel for the packet data session.

10. The method according to claim 9, wherein the method further comprises, when the VoIP session ends, giving the priority back to the packet data session and continuing with data transfer if not yet finished.

11. The method according to claim 9, wherein the method further comprises registering a mobile terminal with a core network, placing the mobile terminal in a dormant session if no voice calls or data transfers are taking place, and maintaining a logical connection between the mobile terminal and the core network.

12. A method, comprising:
requesting and opening a packet data session at a terminal to establish a packet data path on a fundamental channel;
requesting a VoIP session from the terminal;
determining that the packet data session request and the VoIP request occur from the same terminal;
determining if a supplemental channel is present in handling the packet data session;
assigning, if the supplemental channel is not available, a priority to the VoIP request that is higher than a priority of the packet data session request, and sharing the use of the fundamental channel between the VoIP session and the packet data session; and
using, if the supplemental channel is present, the fundamental channel for the VOIP session and using the supplemental channel for the packet data session.

13. The method according to claim 12, wherein the method further comprises, when the VoIP session ends, giving the priority back to the packet data session and continuing with data transfer if not yet finished.

14. The method according to claim 12, wherein the method further comprises registering a mobile terminal with a core network, placing the mobile terminal in a dormant session if no voice calls or data transfers are taking place, and maintaining a logical connection the mobile terminal and the core network.

15. An apparatus, comprising:
a terminal operatively couple by at least one of a fundamental channel and a supplemental channel to a telecommunication system having packet data capability;
the terminal having a packet data session that is established on a packet data path on the fundamental channel;
a VoIP session request that is sent from the terminal to the telecommunication system;
the VoIP request having a priority that is higher than a priority of the packet data session request if the supplemental channel is not present wherein use of the fundamental channel between the VoIP session and the packet data session is shared; and
if the supplemental channel is present, the VoIP session established on the fundamental channel and the packet data session established on the supplemental channel.

16. The apparatus according to claim 12, wherein, when the VoIP session ends, the packet data session is established on the fundamental channel if data transfer is not yet finished.

17. The apparatus according to claim 12, wherein the apparatus further comprises functionality for; registering a mobile terminal with a core network, placing the mobile terminal in a dormant session if no voice calls or data transfers are taking place, and maintaining a logical connection the mobile terminal and the core network.

18. The apparatus according to claim 12, wherein the packet data resources comprise a fundamental channel and a supplemental channel, data transfers taking place on the supplemental channel and voice call traffic and data signaling traffic taking place on the fundamental channel.

19. The apparatus according to claim 12, wherein the mobile terminal is one of a cell phone, a personal data assistant, or a laptop computer.

20. The apparatus according to claim 12, wherein the VoIP session setup is the re-use of existing packet data resources, when the packet data session is already setup.
